(19) United States
(12) Patent Application Publication
(10) Pub. No.: US 2022/0414305 A1
(43) Pub. Date: Dec. 29, 2022

(54) MODELING EFFECTS OF PROCESS VARIATIONS ON SUPERCONDUCTOR AND SEMICONDUCTOR DEVICES USING MEASUREMENTS OF PHYSICAL DEVICES

(71) Applicant: Synopsys, Inc., Mountain View, CA (US)

(72) Inventor: Aaron John Barker, Broomfield, CO (US)

(21) Appl. No.: 17/362,417

(22) Filed: Jun. 29, 2021

(51) Int. Cl. G06F 30/3308

(52) U.S. Cl. CPC G06F 30/3308; G06F 2111/10

(57) ABSTRACT

Samples of metrics measured on physical devices are selected from a larger number of samples. The samples are selected based on the distributions of the measured metrics. A set of model instances are constructed that correspond to the selected set of samples. The model instances have parameters, which are set such that simulation of the model instances using the parameters predicts metrics that match the measured metrics from the set of samples. The principal components of the variances of the parameters is calculated. Non-linear models are fitted to the parameter variances as a function of the principal components. Statistical variations of the principal components are applied to the non-linear models to yield statistical variations in the parameters; and these are applied to simulations of model instances to yield statistical variations of a property of the device being simulated.

### GOVERNMENT RIGHTS LEGEND

This invention was made with government support under Contract W911NF-17-9-0001 awarded by the Office of the Director of National Intelligence, Intelligence Advanced Research Projects Activity (IARPA), via the U.S. Army Research Office. The government has certain rights in the invention.

### TECHNICAL FIELD

The present disclosure generally relates to a modeling system. In particular, the present disclosure relates to a system and method for providing modeling and simulating devices, such as superconductor and semiconductor devices, in light of process variations during manufacturing.

### BACKGROUND

As technology advances, superconductor and semiconductor products are becoming increasingly complex. Transistors, Josephson junctions and other devices are becoming smaller, die sizes are becoming larger and the number of devices on a die is increasing. While the task of developing these products is becoming more complex, market pressures are shortening the time available to bring new products to market. It is costly to start fabrication of new products if there are defects in the design. As a result, the simulation of these devices is becoming ever more important, but also ever more difficult.

The techniques used to fabricate superconductor and semiconductor products are also becoming more complex and challenging. Any process will have variations that lead to variations in the finished product. Given the tight tolerances on products, the short turnaround times, and the costliness of mistakes, it is important to account for these process variations in the simulation and modeling of superconductor, semiconductor and other devices.

### SUMMARY

In one aspect, a set of samples of metrics measured on physical devices is selected from a larger number of samples. Examples of devices include superconductor and semiconductor devices. The measured metrics are not all the same and have some distribution. Samples are selected based on the distributions of the measured metrics. A set of model instances are constructed that correspond to the selected set of samples. The parameters for the model instances are set, such that simulation of the model instances using the parameters predicts metrics that match the measured metrics from the set of samples. The principal components of the variances of the parameters is calculated. Non-linear models are fitted to the parameter variances as a function of the principal components. Statistical variations of the principal components are applied to the non-linear models to yield statistical variations in the parameters; and these are applied to simulations of model instances to yield estimates of statistical variations of the device being simulated.

Other aspects include components, devices, systems, improvements, methods, processes, applications, computer readable mediums, and other technologies related to any of the above.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIGS. 1A and 1B are flow diagrams illustrating the effect of process variations on simulation of a device.

FIGS. 2A and 2B are flow diagrams of processes for converting measurement samples from physical devices to statistical variations in the simulation of such physical devices.

FIG. 3 shows an I-V curve for a Josephson junction superconductor device.

FIGS. 4A and 4B show the distributions of samples for individual metrics of a superconductor device across several dies.

FIG. 4C shows the bivariate distribution of two metrics of a superconductor device across several dies.

FIG. 5 shows an excerpt from a table of the model parameters {Y} for a superconductor device.

FIG. 6 shows a summary screen of a principal component analysis for a superconductor device.

FIG. 7 shows a non-linear model fit to model parameters as a function of principal components for a Josephson junction superconductor device.

FIGS. 8A and 8B show a comparison of the Josephson junction's measured metrics with the simulated metrics, respectively.

FIGS. 9A and 9B show the distribution of samples for a metric of a semiconductor device.

FIG. 10 shows the bivariate distribution of two metrics, one from an negative metal oxide semiconductor (NMOS) transistor and the other from a positive metal oxide semiconductor (PMOS) transistor.

FIG. 11 shows BSIM4 model parameters extracted for three samples.

FIGS. 12A and 12B show correction of the extraction of model parameters for a semiconductor device.

FIG. 13 shows a non-linear model fit to model parameters as a function of principal components for an NMOS transistor semiconductor device.

FIGS. 14A and 14B show a comparison of the measured metrics with the simulated metrics, respectively, for a complementary metal oxide semiconductor (CMOS) process.

FIG. 15 shows a comparison of physical parameters with principal components for a CMOS process.

FIG. 16 depicts a flowchart of various processes used during the design and manufacture of an integrated circuit in accordance with some embodiments of the present disclosure.

FIG. 17 depicts a diagram of an example computer system in which embodiments of the present disclosure may operate.

### DETAILED DESCRIPTION

Aspects of the present disclosure relate to modeling effects of process variations on superconductor and semiconductor devices, based on measurements of physical devices. The simulation of devices is an important part of the design and development of superconductor and semiconductor products. At the same time, any superconductor or semiconductor fabrication process will have process variations that result in differences between the same device design manufactured on different die or wafers. It is desirable to include the effect of these process variations in simulations of devices.

However, it can be difficult to understand or quantify process variations in a manner that can be easily used in simulations. Fabrication processes, especially at the most advanced technology nodes, are not always well understood. In addition, the metrics that are measurable by the fab are often not the quantities that are used in simulation modeling, so it is not clear how variations in measured metrics should be modeled in the simulations. Furthermore, the fab typically will measure a large volume of metrics across many different die and wafers. It can be computationally expensive to use a brute force approach to analyze all of these measured samples. It also may not lead to the best results, because some measurements may be anomalous outliers that are not really representative of the normal process variations and which will disproportionately skew the analysis.

In one aspect, a smaller set of samples is selected from the larger volume of available samples, based on the distribution of the measured metrics. As a result, a smaller number of samples may be used while still adequately representing the effects of process variations.

Parameterized models of the devices are used in simulation. A set of model instances is created by setting the model parameters based on the measured metrics in the selected set of samples. Interactions between the different model parameters are included by calculating the principal components of the variances of the model parameters, and then expressing the parameters as non-linear functions of the principal components. The effects of process variations may then be modeled by considering the statistical variations of the principal components, and propagating these variations through the non-linear models to the model parameters and then through simulations to the device property of interest.

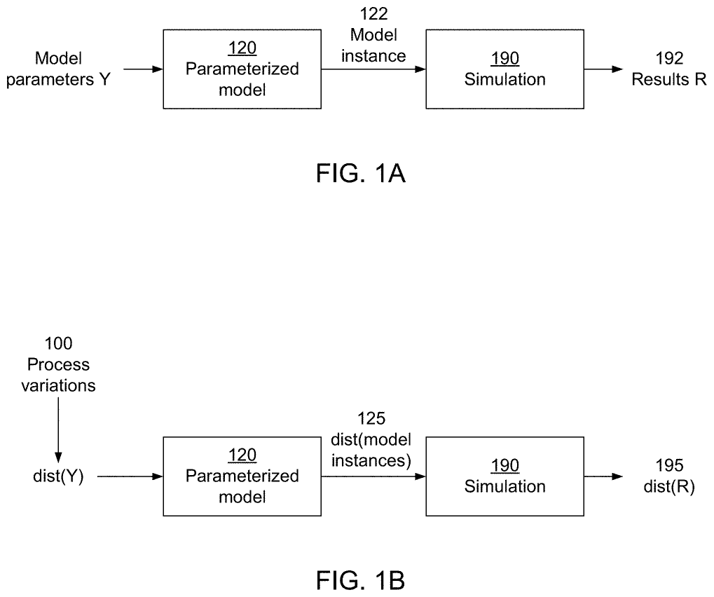

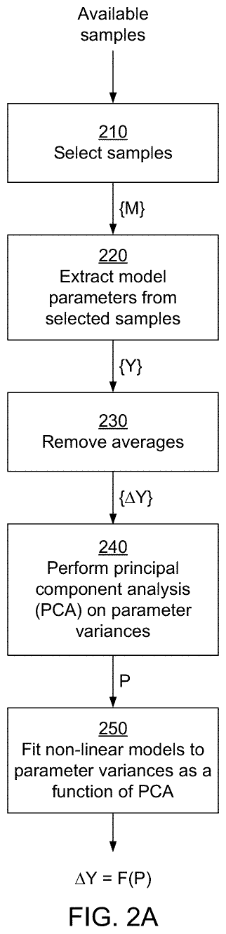

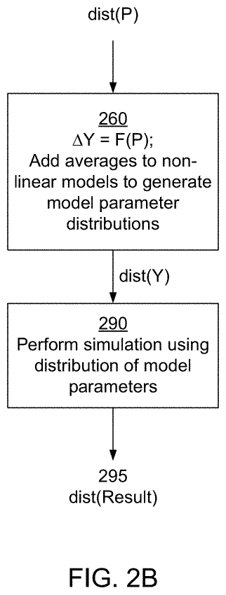

FIGS. 1 and 2 illustrate an example of this approach in more detail. FIG. 1A shows a simulation flow. A parameterized model 120 of the device is used in the simulation 190. The parameters for the model are denoted by Y=(y1, y2, . . . yJ) where yj, j=1 . . . J, are the individual parameters. The model for a specific device is defined by selecting values for the parameters Y, and this is referred to as a model instance 122. The model instance 122 is used in the simulation 190, which produces some result 192 that usually is a predicted characteristic, behavior or other property of the device being simulated.

As shown in FIG. 1B, even though a device may have nominal values for the model parameters 120, process variations 100 will cause variations in the parameter values so there will be a distribution 125 of parameters Y, denoted as dist(Y) in FIG. 1B. This results in corresponding distributions 125 of model instances and distributions 195 of predicted results dist(Results).

However, the dist(Y) is not known a priori and is not easily measurable. The fab can measure certain metrics, but they typically are not the model parameters Y. FIGS. 2A and 2B are flow diagrams of example processes for estimating statistical variations in the model parameters Y based on the measured metrics.

FIG. 2A begins with a large number of available sample measurements. The samples include different metrics measured on physical devices, for example as measured on different dies and wafers. In some cases, the physical devices may be multiple physical instances of the same device design and all manufactured using the same process (e.g., same process node). The metrics measured are denoted by M=(m1, m2, . . . mI) where mi, i=1 . . . I, are the different metrics measured. Each sample includes the metrics M measured on a physical device. There can be a very large number of samples.

A smaller but representative set of samples {M} is selected 210 from the larger volume of available samples, for example as described below. As a result of process variations, the metrics M measured in the available samples are not all the same and have some distribution. The samples are selected for inclusion in the set {M} based on the distributions of the measured metrics M. For example, the set {M} may include samples that represent the lower specification limit (LSL) and upper specification limit (USL) of the wafer acceptance test (WAT) or scrap criteria. The set {M} may also include samples that represent the +3σ and −3σ quantiles of metric m1, the +3σ and −3σ quantiles of metric m2, and so on for all of the other metrics m1. Other quantiles may also be used. Samples may also be selected based on bivariate and other multi-variate distributions. For example, the bivariate distributions of metrics m1 and m2 may be fit to an elliptical distribution with a major and a minor axis. Samples that represent quantiles along the major and minor axis may also be selected for inclusion in the set {M}.

The metrics M in the sample set are a measure of the process variations, but they typically are not the same as the model parameters Y and cannot be easily used in simulations of devices. Rather, a set of model instances {Y} corresponding to the set of selected samples {M} is created 220 by setting parameters such that simulation of the model instances using the parameters {Y} results in or predicts metrics that match the measured metrics {M} from the selected sample set. An exact match may not be possible. In one approach, the predicted metrics are within a certain threshold of the measured metrics. In an alternative approach, the parameters that result in metrics closest to the measured metrics are used. This process may be referred to as model extraction. Model parameters {Y} are extracted from the sample set {M}. Because there is variation in the measured metrics {M}, there will also be variation in the corresponding model parameters {Y}.

If a complex physical model were used, the variation in the model parameters {Y} may be explained by variations in the corresponding physical quantities. However, that can be complex and incomplete. Instead, a principal component approach is used. The parameters {Y} are reduced 230 by their averages, yielding the variances of the parameters {ΔY}, where ΔY=Y−average(Y). Different estimates of the average may be used.

The principal components of these variances {ΔY} are calculated 240. The principal components are denoted by P=(p1, p2, . . . pK) where each pk is one principal component (e.g., eigenvector). The set of principal components P may be cut off at a certain number K, rather than using the full basis set. The parameter variances {ΔY} could be expressed as a linear combination of the principal components P, but this would ignore any interactions between components pk. Instead, non-linear models are fit 250 to the parameter variances {ΔY} as a function of the principal components P: ΔY=F(P) where F( ) is non-linear. This can be expressed as a set of non-linear relations for each model parameter: Δyj=fj(P) where j is an index to the model parameters. Because there is variation in the model parameters {ΔY}, there will also be variation in the principal components. For convenience, the principal components may be normalized so that this variation has mean=0 and standard deviation=1.

The effect of process variations, as evidenced by the measured metrics {M}, can now be accounted for during simulation as shown in FIG. 2B. The principal components P may be assumed to have a certain statistical distribution dist(P), preferably Gaussian with mean=0 and standard deviation=1 by scaling the principal components appropriately. Statistical variations of the principal components may then be applied 260 to the non-linear models ΔY=F(P) to yield statistical variations in the model parameters: dist(ΔY) and dist(Y) by adding the averages back in. This, in turn, can be applied 290 to simulations of model instances to yield statistical variations dist(Result) 295 of desired properties of the device being simulated.

For example, Monte Carlo simulations of the devices may be performed to determine how the device will behave in light of the variations. In Monte Carlo simulation, many instances of the device are simulated by selecting values of the principal components according to the distribution dist(P). Each instance produces a Result, and the aggregate collection of Results from the simulation produce the distribution dist(Result) 295.

### Example for a Superconductor Device

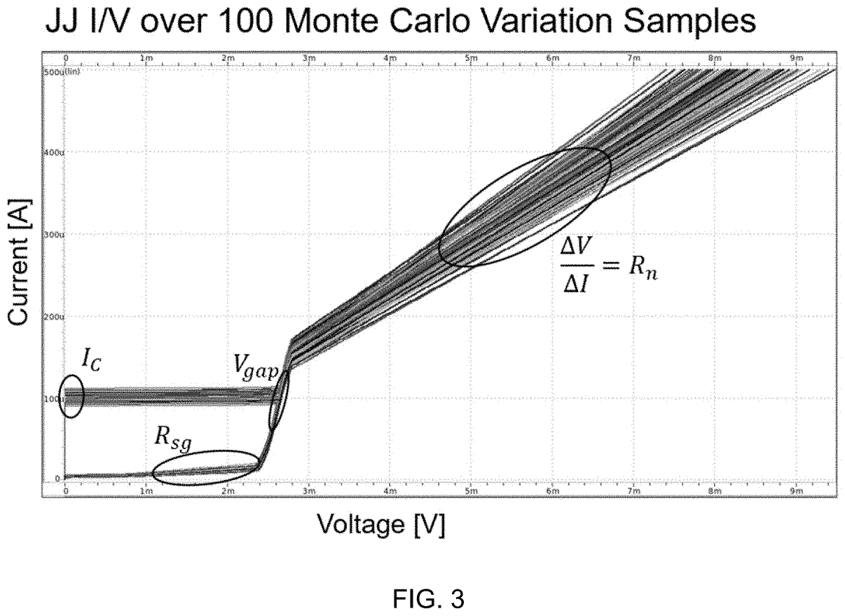

FIGS. 3-8 illustrate an example for a Josephson junction superconductor device. For these types of devices, the measured metrics may be based on I-V curves, process control monitors, wafer acceptance tests and various circuit metrics. FIG. 3 are current-voltage (I-V) curves for 100 Monte Carlo samples of a Josephson junction, illustrating various metrics. Example metrics include icrit (I_{C})=critical current, rnorm (Rₙ)=normal resistance, Rsg=subgap resistance, Vgap=gap voltage, and delV=gap width. Additional metrics may include: ring oscillator delay, where the ring in this case is a ring of Josephson junctions that are different from the ring of inverters or other static complementary logic gates used in CMOS, passive transmission line+driver/receiver combinations for various lengths and other geometry considerations, probed path delays, measured inductance, various Superconducting Quantum Interference Devices (SQUIDs). In the example of FIGS. 3-8, eight different metrics were considered: icrit, rnorm, Rsg, Vgap, delV, Rshunt, Lshunt, and JJ cap. These metrics describe Josephson junction electrical characteristics. Approximately 80 samples were selected from 200 total samples available.

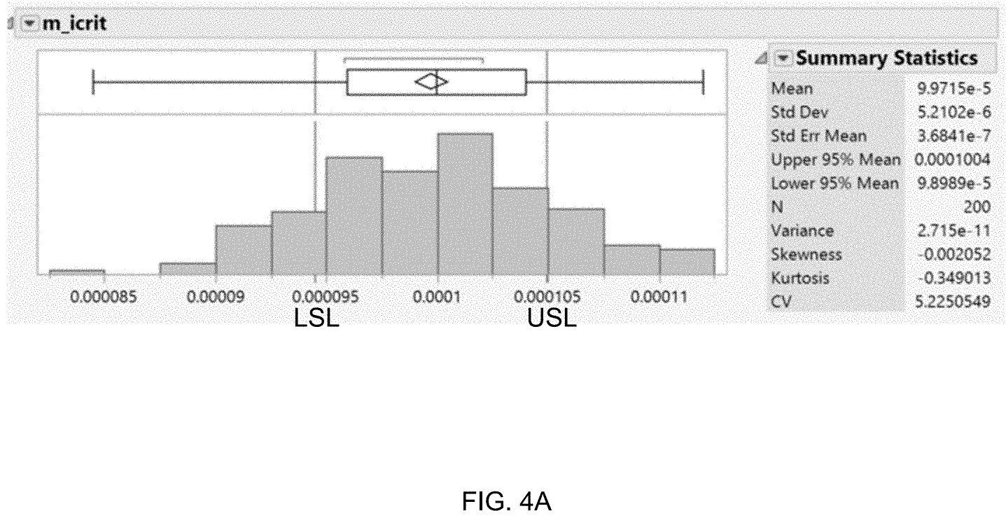

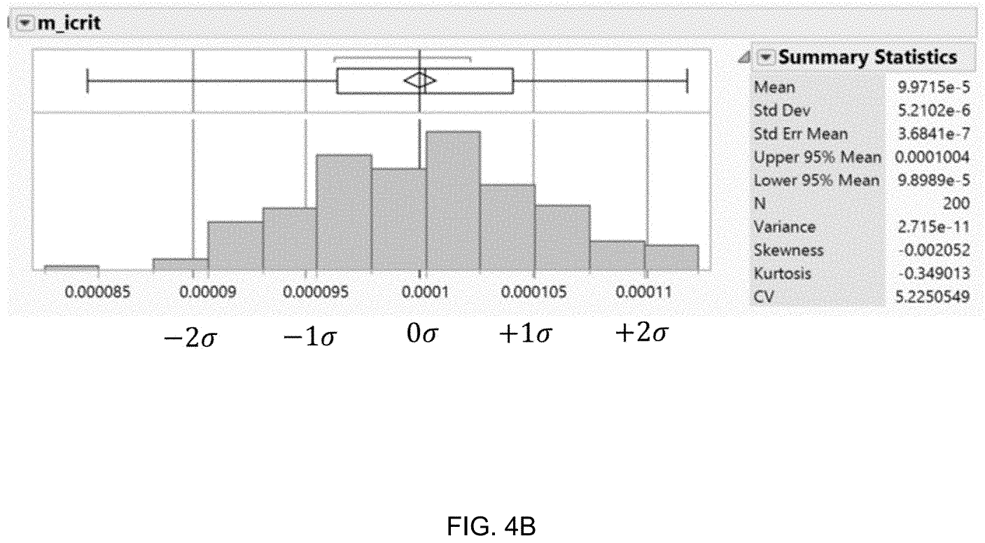

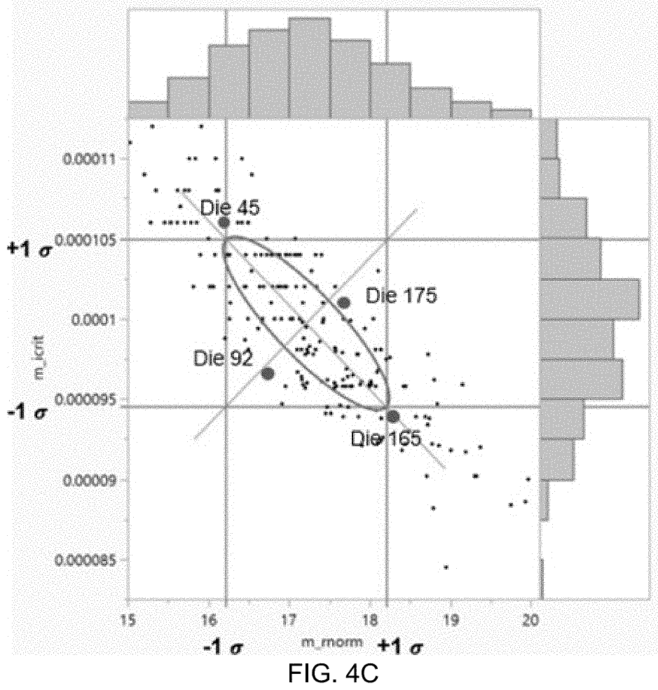

FIGS. 4A-4C illustrate the selection step 210 of FIG. 2A. FIG. 4A shows a histogram of the distributions of the 200 samples for metric icrit. The m_ prefix on the metric name indicates measured metric (e.g., m_icrit). From this distribution, samples that represent the upper and lower process limits are selected: LSL and USL in FIG. 4A. This is repeated for each of the metrics. Multiple samples may be selected for each process limit. In FIG. 4B, samples that represent the mean and the +/−1σ and +/−2σ quantiles for each metric are selected. Multiple samples may be selected for each quantile, for example if multiple samples are close to that quantile. Where more samples are available, samples representing +/−3σ may also be used since that is a common cutoff for rejecting devices during production. Alternatively, samples may be selected for +/−3σ, +/−2σ, and +/−1σ. The 10th and 90th percentiles or other quantiles may also be used. The extreme maximum and minimum are not preferred because they may be anomalous and often might be scrap.

FIG. 4C shows the bivariate distribution of the two metrics icrit and rnorm. Additional samples are selected based on this distribution. In one approach, the bivariate distribution is fit to an equiprobability density ellipse, shown as the blue ellipse in FIG. 4C. FIG. 4C has a probability ellipse at 0.41624, so a bit less than half of the samples are inside the ellipse. This technique is used to align a bivariate normal ellipse to the −1σ and +1σ quantiles of each of the single-variate distributions (given that they are correlated). This denotes a joint probability. For non-Gaussian distributions, a Box-Cox transform may be applied to the samples prior to fitting the probability ellipse. Box-Cox is a known method in statistics to take non-Gaussian distributions (in the presence of skewness) and transform them into Gaussian distributions.

The ellipse has a major and minor axis and samples that fall close to the major and minor axis just outside the ellipse are also selected. In FIG. 4C, the samples for dies 45, 92, 165 and 175 are selected. These samples are different than the samples selected in FIG. 4A, which are die 95 and 170 for icrit, and also different than the samples selected in FIG. 4B. The samples selected in FIG. 4C based on the bivariate distribution represent different aspects of the process variation, including correlations between different metrics. This selection can be repeated for bivariate distributions of all pairs of metrics. Alternatively, it may be repeated only for pairs that show some amount of correlation.

The selection process results in a set of samples {M} that is smaller than the starting point of all available samples, but that is still representative of the process variations. Model parameters Y are fit to each sample M, resulting in a set of model parameters {Y} that corresponds to the metrics {M}. For example, if the models are HSPICE, then a multi-variate optimization problem is solved to find the HSPICE parameters {Y} which predict metrics that match the measured metrics {M}.

In one approach, this is performed by Synopsys' Mystic tool, which performs a kind of model fitting/model extraction that aligns the HSPICE parameters (.model card coefficient values) such that the metrics predicted in HSPICE will align to the same measured metrics. Possible techniques for this multi-objective multi-variate optimization problem include techniques not too dissimilar to classical methods such as Design of Experiments (DoE), Response Surface Modeling (RSM) and Surrogate Based Optimization (SBO).

Note that each sample in set {M} was selected according to some criteria (e.g., +1σ point for a specific metric m1), but all of the metrics for that sample are used to fit the corresponding model parameters Y. The number of metrics should be large enough to allow the performance of a proper model fit. If many different model parameters {Y} can be found that fit the measured metrics {M}, then the number of metrics may be too small to properly constrain the solution {Y}. For example, in the Mystic tool, the user may change the DoE patterning (pseudo-RNG seed). If different seeds produce the same solution (equivalent .model card), then this is an indication that the metrics are sufficiently diverse.

In this example, the model is a SPICE model, for example BSIM4 or BSIM-CMG from the BSIM Group for CMOS devices or a Josephson junction model for superconductor electronics. Examples of model parameters yj for a Josephson junction device include critical current (xj), normal resistance (icrn), subgap resistance (vm), Josephson junction capacitance (xc), gap voltage (vgap), gap width (delv), series inductance (lser) and shunt resistor (xr, lsh0, lsh1−lsh=kinetic inductance of the resistor—i.e. Drude model/momentum/kinetic energy of the electron due to its mass).

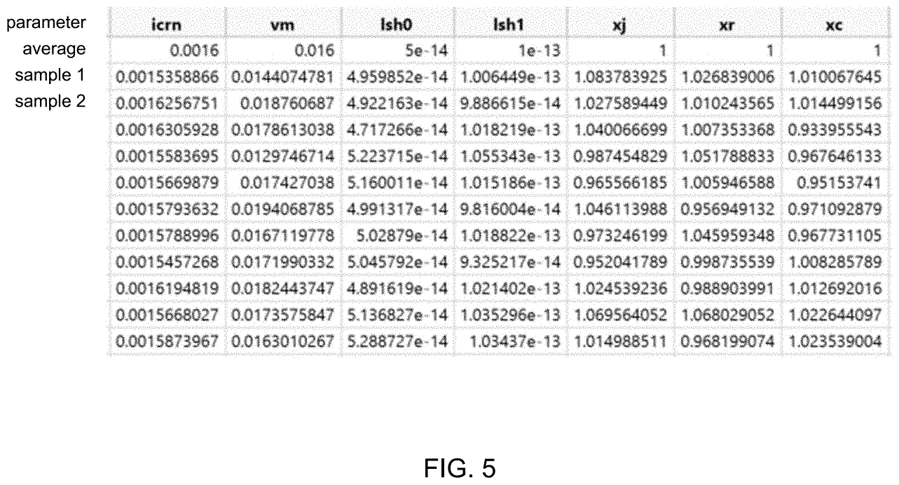

FIG. 5 shows an excerpt from a table of the model parameters {Y}. In this example, the parameters yj include icrn, vm, lsh0, lsh1, etc. as indicated by the labels of each column. The first row in the table is the average value for each parameter. Each of the other rows represents a different sample, where the value in the cell is the variance from the average value. FIG. 5 tabulates the variances {ΔY} of the model parameters. This is the result of steps 220 and 230 of FIG. 2A.

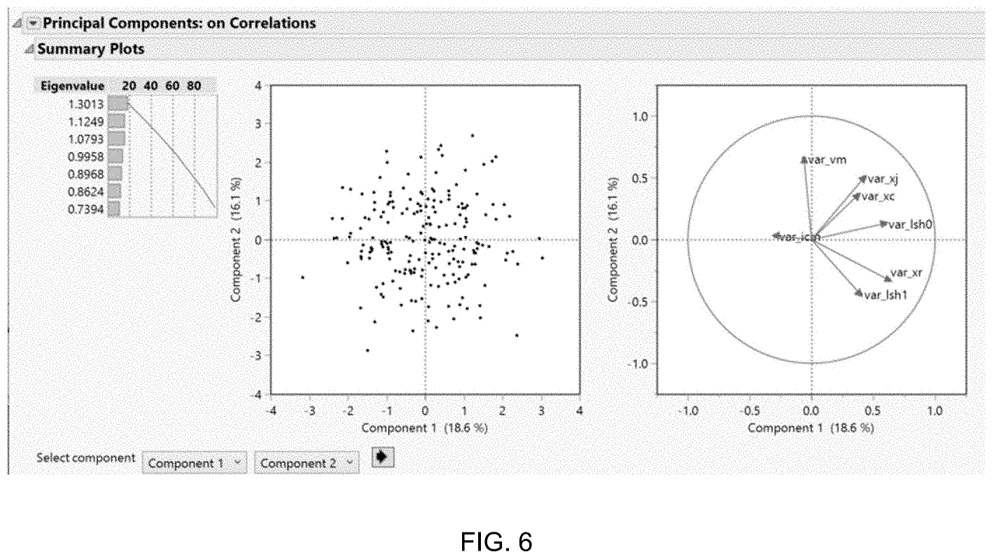

A principal component analysis is applied to the set of variances {ΔY}, which is step 240 in FIG. 2A. FIG. 6 shows a summary screen of this analysis. The upper left graphic lists the strength (eigenvalue) of each of the principal components (eigenvectors) in descending order. The strongest principal component p1 has eigenvalue 1.30, component p2 has strength 1.12, component p3 has strength 1.08, and so on. The curve indicates the percentage of the system “encapsulated” by each of the PCA terms. The curve is cumulative as a function of PCA term. The other two plots in FIG. 6 show the correlation between components p1 and p2.

Not all of the principal components have to be used. The K strongest components may be used as the basis for fitting the non-linear models, and the remaining principal components discarded. For example, principal components that have an eigenvalue greater than 0.1 (or some other threshold) may be kept. PCA is a method which takes an original set of n variables which are likely to be interrelated and replaces them using m uncorrelated variables (“in an alternate eigenspace”) as a linear combination of the original variables, so that the majority of the variation can be accounted for using only a few principle components. Usually, an eigenvalue of 1.0 is used as the cutoff, but here a lower cutoff of 0.1 is used in this case, in order to capture not only principal effects but Nth order effects as well as non-linear relationships. Other predefined minimum number of principal components or criteria for selecting principal components may be used.

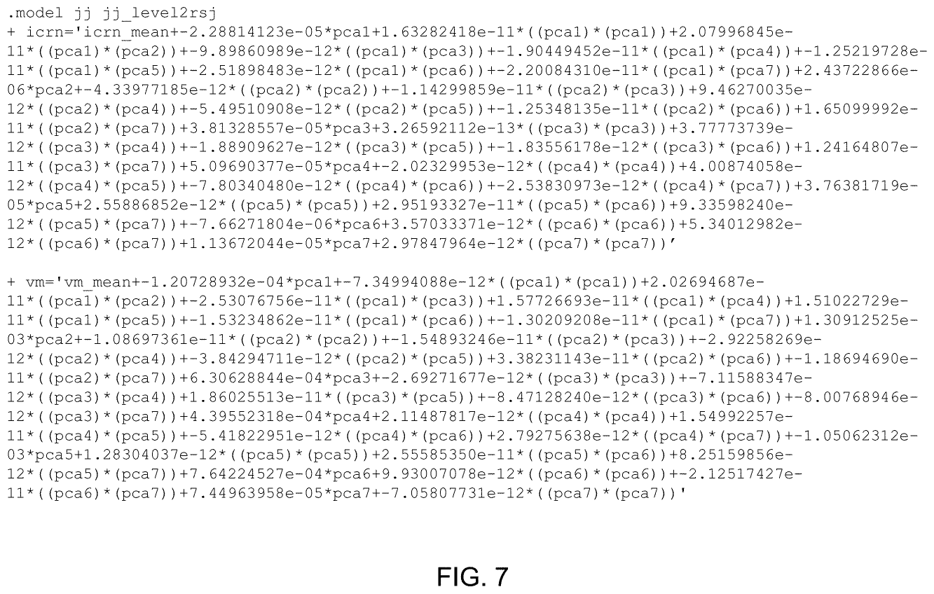

In the final step 250 in FIG. 2A, the model parameters Y are fitted to non-linear models as a function of the principal components P. Other variables, such as device geometry, may also be used in addition to the principal components P. For example, icrn may be expressed as a function of principal components and also of Josephson junction diameter. FIG. 7 shows two examples. The top expression is the model parameter icrn as a function of the principal components pca1, pca2, . . . pca7. This expression is a second order expression using the seven strongest principal components. In this expression, icrn mean is the average value and the remaining terms are the variance Δicm expressed as a second order polynomial function of the principal components. The bottom expression is for the model parameter vm, which takes a similar form. The principal components may be modelled as Gaussian distributions with mean=0 and standard deviation=1. These statistical variations may then be propagated through the non-linear models and the simulations to produce a distribution of simulated results, as shown in FIG. 2B.

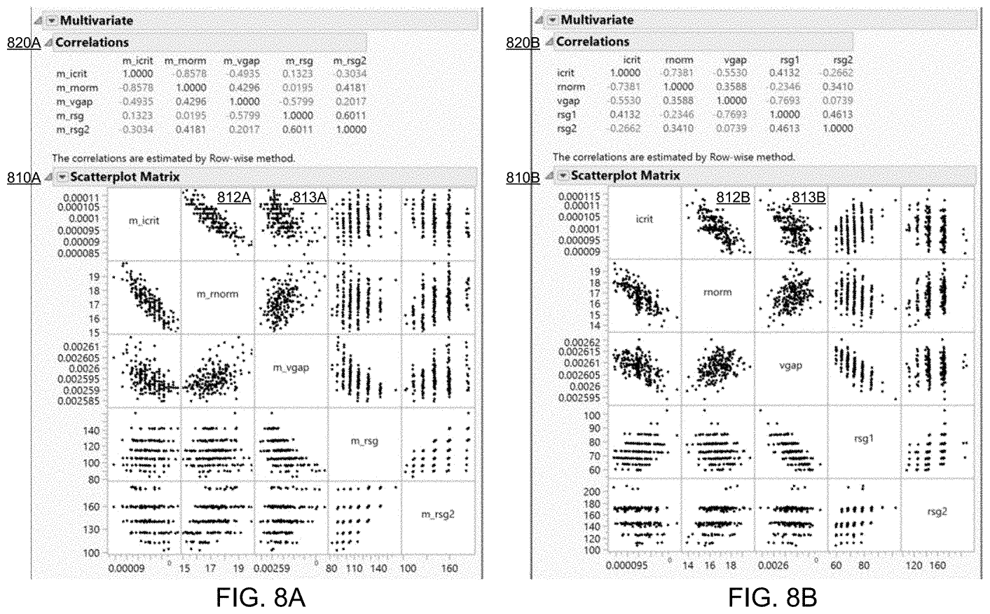

FIGS. 8A and 8B show a comparison of the measured metrics with the simulated metrics, respectively. In each figure, the 5×5 grid 810A and 810B labeled “Scatterplot Matrix” shows the bivariate distributions of the five metrics icrit, rnorm, vgap, rsg and rsg2. The second boxes 812A and 812B in the first row is the bivariate distribution of icrit and rnorm, the third boxes 813A and 813B in the first row is the bivariate distribution of icrit and vgap, and so on. The tables 820A and 820B labeled “Correlations” at the top shows the correlations between pairs of metrics. FIG. 8A is the original measured metrics. FIG. 8B are bivariate distributions simulated using the flow of FIG. 2B. The simulated bivariate distributions are well matched to the actual physical measurements.

The physical devices that were measured may also appear in netlists being simulated. The probe and measurement configuration used to measure metrics in the fab may be simulated, with process variations accounted for by the simulated metrics described above.

### Example for a CMOS Device

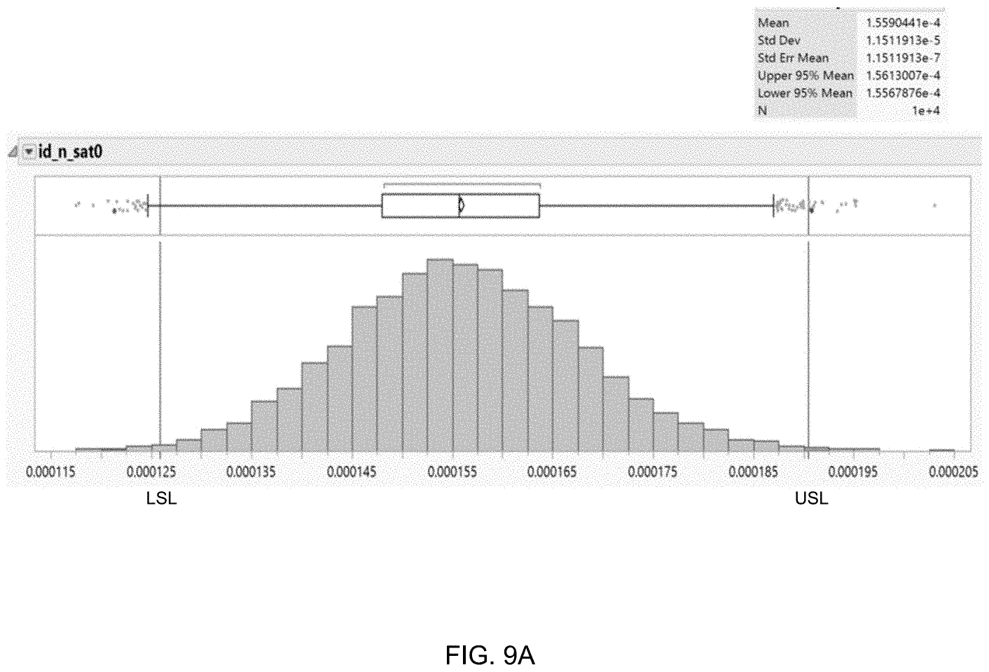

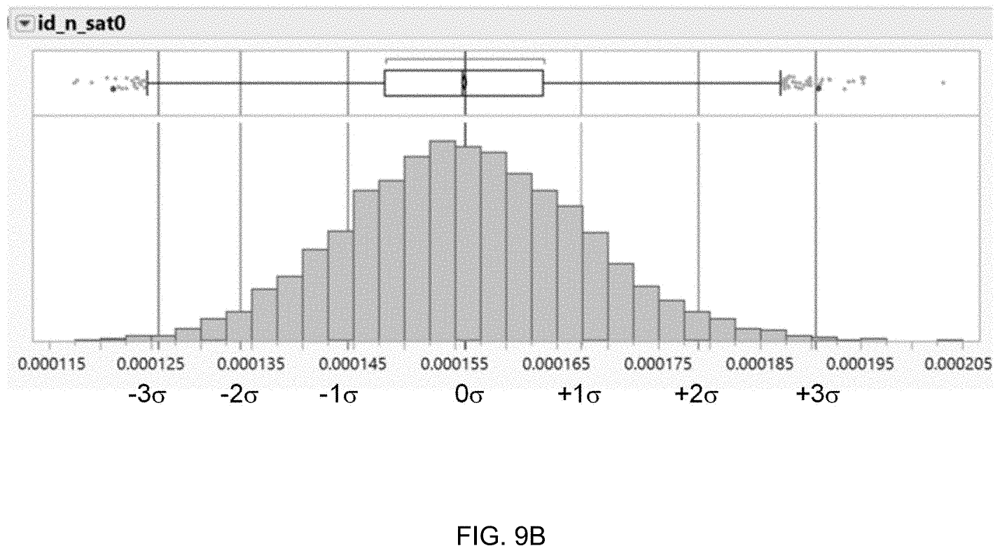

FIGS. 9-14 illustrate an example for a CMOS device. For these types of devices, the measured metrics may be based on I-V curves, process control monitors, wafer acceptance tests and various circuit metrics. For NMOS and PMOS devices, metrics may include IdSat—drain current saturation region, IdLin—drain current linear region, VtSat—threshold voltage saturation region, VtLin—threshold voltage linear region, Id_subVt—drain leakage current subthreshold voltage region, Igate—gate leakage current, gm (dIds/dVgs)—transconductance, gds (dIds/dVds)—output conductance, gmb (dIds/dVbs)—bulk transconductance, gain (gm/gds)—intrinsic gain, gm_eff (gm/Ids)—transconductor efficiency, ft (gm/Cgs)—transit frequency, Cgate—intrinsic gate capacitance, Cd/s—drain/source capacitance, Cj—diffusion capacitance, and Cov (Miller good/bad)—overlap capacitance. For ring oscillators, examples of metrics include FO1, FO4, FO8, FO16 and FO32, which are ring oscillators of various sizes. FO16 is a ring oscillator with a fanout of 16. For static noise margin, example metrics include Static Complementary gates. These metrics may be repeated for devices of different sizes and layout configurations. In this example, 10 different metrics were considered, and about 100 samples were selected from 10,000 total samples available.

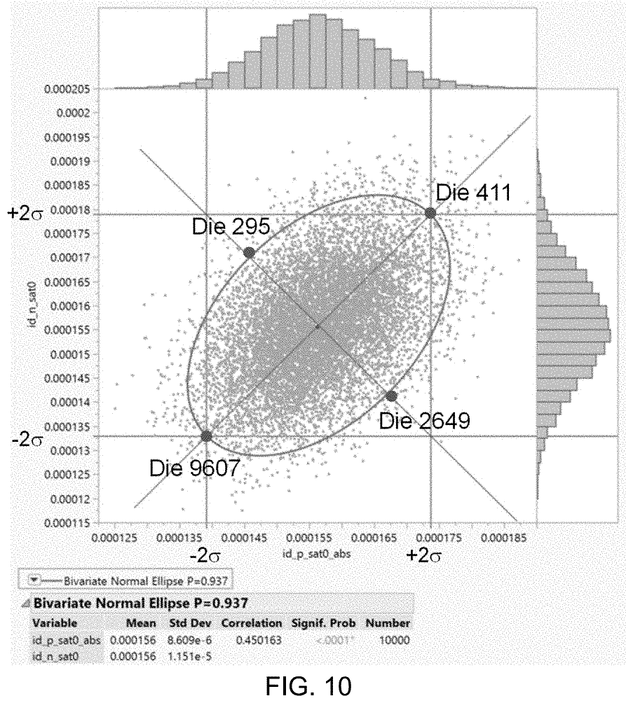

FIGS. 9A, 9B and 10 illustrate the selection step 210 of FIG. 2A. FIGS. 9A and 9B show a histogram of the distributions of the samples for metric n_sat0. From these distributions, samples that represent the upper and lower process limits (USL and LSL) are selected in FIG. 9A and samples that represent different quantiles are selected in FIG. 9B. FIG. 10 shows the bivariate distribution of two metrics n_sat0 and p_sat0. Additional samples are selected based on this distribution: dies 295, 411, 2649 and 9607.

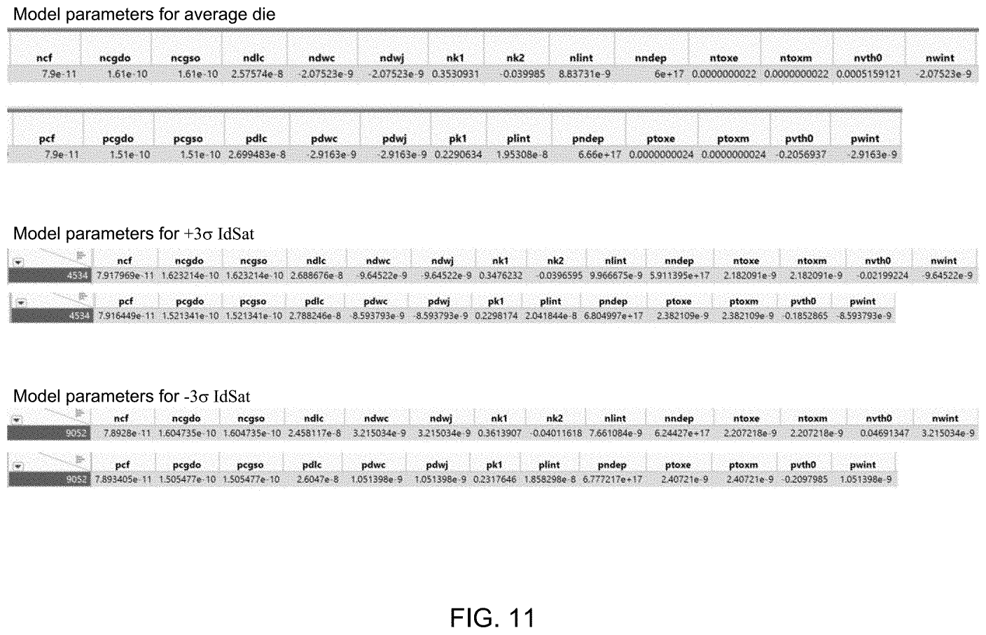

In step 220 of FIG. 2A, model parameters {Y} are extracted corresponding to the samples {M}. In this example, the models are SPICE models. FIG. 11 shows the extracted model parameters for an average die and for the samples corresponding to +3σ quantile for metric IdSat and to −3σ quantile for metric IdSat. The average die may be an actual single sample. In one approach, the average value of each metric is calculated and the die(s) that are closest to those average values is the average die. Alternatively, the average die may not be an actual sample. It may be a composite sample calculated from a number of different samples.

In this example, the model parameters include the following n-type parameters ncf—fringing field capacitance, ncgdo—drain-gate overlap capacitance, ncgso—source-gate overlap capacitance, ndlc—length offset for CV, ndwc—width offset for CV, ndwj—offset of the S/D junction width, nk1—first body bias coefficient, nk2—second body bias coefficient, nlint—channel length offset, nndep—channel dopant concentration, ntoxe—electrical gate equivalent oxide thickness, ntoxm—gate equivalent oxide thickness for extracted parameters, nvth0—long channel threshold voltage @ VBS=0, nwint—channel width offset and the corresponding p-type parameters.

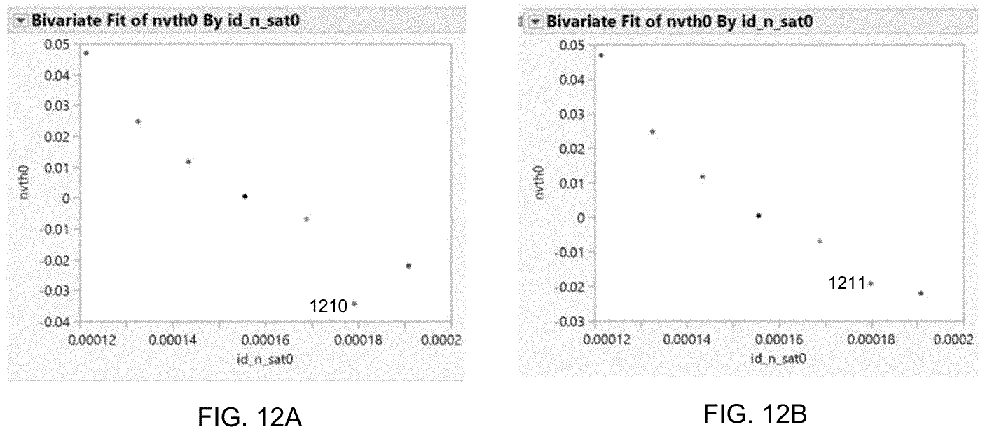

FIGS. 12A and 12B show correction of the extraction process. Due to model ambiguity, the extraction process may result in non-monotonic trends in the model parameters for samples progressing from −3σ to +3σ. FIG. 12A plots the extracted parameter nvth0 for the samples selected for quantiles −3σ to +3σ for n_sat0. The extraction of sample 1210 is inconsistent with the other samples, so the extraction is reperformed but constraining nvth0, resulting in the more consistent point 1211 shown in FIG. 12B.

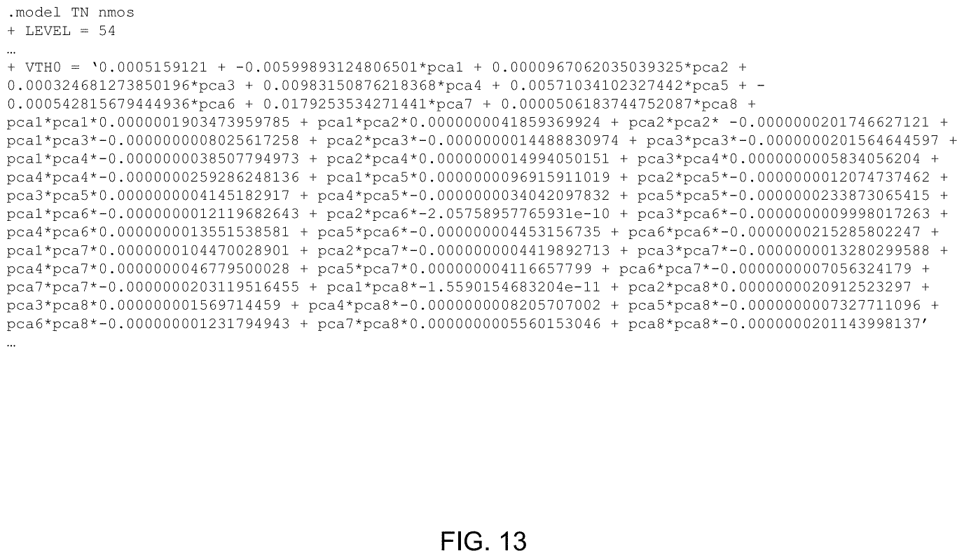

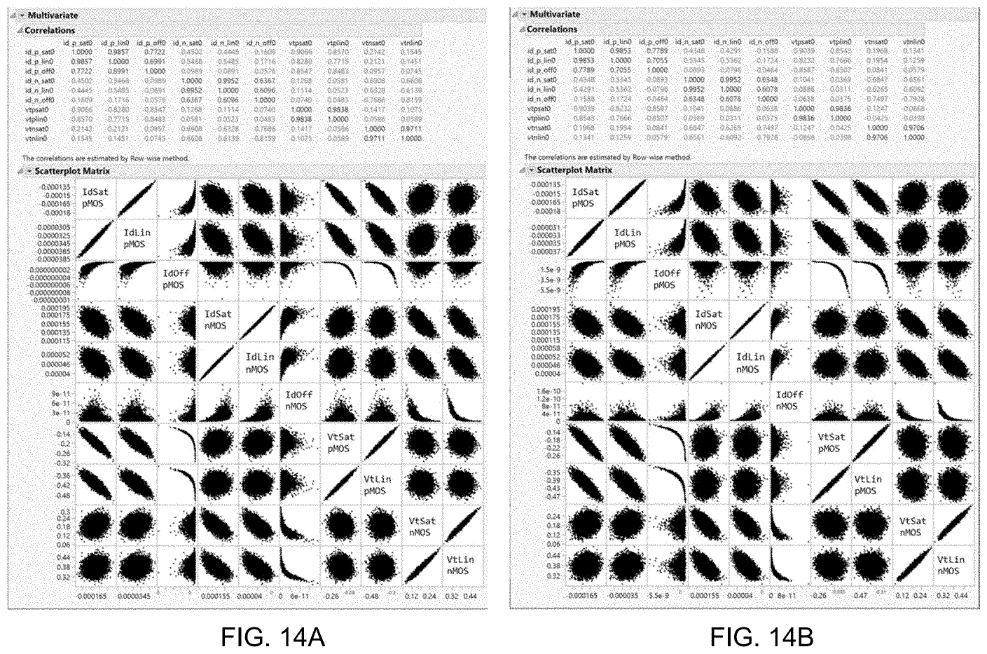

Steps 230-250 of FIG. 2A are performed as described previously. FIG. 13 shows an example non-linear curve fit for model parameter vth0 as a function of the principal components pca1, pca2, . . . pca8. This expression is a second order expression using the eight strongest principal components. The first term is the mean, the next eight terms are the linear terms for each component, and the remaining terms are the second order terms for the products of two components. FIGS. 14A and 14B show a comparison of the original measured metrics in FIG. 14A with the simulated metrics in FIG. 14B.

### Additional Considerations

The quality of the results from this approach depends on the number of samples in the sample set {M} and the diversity of the sample set. The minimum number of samples N required to fit a system with degrees of freedom (DoF) to a polynomial of order (O) is given by

N=(DoF+O)!/(DoF!*O!) (1)

In the examples above, DoF is the number of principal components and O is the order of the non-linear polynomial. Eqn. (1) assumes the number of samples is a good representation of the underlying system. In many physical systems, the main components of the physical system can be described by approximately seven degrees of freedom (DoF=7). For semiconductor devices, degrees of freedom in the fabrication process may include oxide thickness, dopant concentrations, critical dimension (CD) linewidth control, flat-band voltage, drain-source resistance, etc. At least a second order polynomial (0=2) is required to model higher order effects. This yields N=36, and more is usually better. Selecting a sample set {M} with at least twice this number of samples (72) or even more (e.g., greater than 100) can help mitigate some randomness of error in the data. In addition, it is preferable that samples can be selected from at least five candidate samples (i.e., the +3σ sample is selected from at least five samples around the +3σ quantile). The likelihood of a single sample exhibiting a 3σ condition is approximately 1/740. To get five candidates for each of two samples then requires 5×2×740=7400 available samples to choose from. From the original 7400 samples, a set of 72 samples is selected.

In another aspect, assume that I is the number of measured metrics, then the number of samples N to obtain a good estimate of the principal components is given by

N=DoF*I (2)

or even twice this number or more.

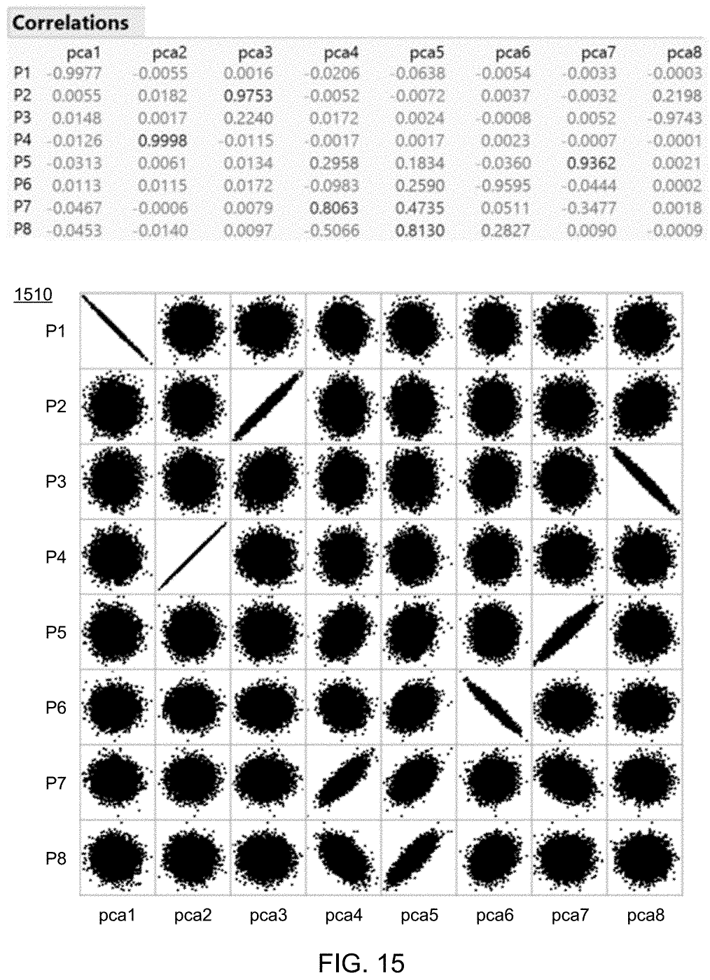

In some cases, the principal components may also be related to physical parameters. FIG. 15 contains a grid 1510 of bivariate distributions. Each row in FIG. 15 is a physical parameter P1-P8 and each column is one of the eight strongest principal components pca1-pca8. Each box in the 8×8 grid shows the bivariate distribution of each physical parameter against each principal component. If the distribution is a circular cloud, then the two quantities are not well correlated. If the distribution is a line, then the two quantities are correlated. It can be seen that the first eight principal components are well correlated against physical parameters.

The principles above have been explained using superconductor and semiconductor devices as examples. However, they may also be applied to other devices. The technique can be applied to any manufacturing process which has variation, not limited to electronics, but also including mechanical, structural, chemical, nuclear, optical, pharmaceutical, biological, and other systems as well.

### EDA Flows

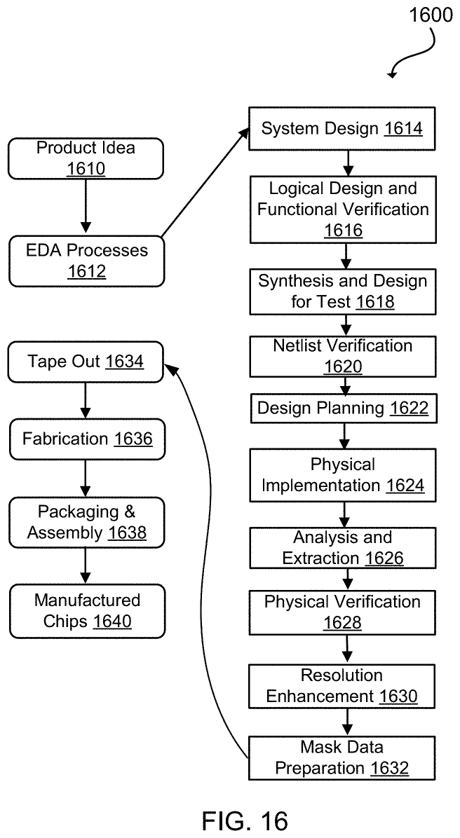

FIG. 16 illustrates an example set of processes 1600 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 1610 with information supplied by a designer, information which is transformed to create an article of manufacture that uses a set of EDA processes 1612. When the design is finalized, the design is taped-out 1634, which is when artwork (e.g., geometric patterns) for the integrated circuit is sent to a fabrication facility to manufacture the mask set, which is then used to manufacture the integrated circuit. After tape-out, a superconductor or semiconductor die is fabricated 1636 and packaging and assembly processes 1638 are performed to produce the finished integrated circuit 1640.

Specifications for a circuit or electronic structure may range from low-level transistor or Josephson junction material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding tools of that layer (e.g., a formal verification tool). A design process may use a sequence depicted in FIG. 16. The processes described may be enabled by EDA products (or tools).

During system design 1614, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 1616, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 1618, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 1620, the netlist is checked for compliance with timing constraints and for correspondence with the HDL code. During design planning 1622, an overall floor plan for the integrated circuit is constructed and analyzed for timing and top-level routing.

During layout or physical implementation 1624, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 1626, the circuit function is verified at the layout level, which permits refinement of the layout design. During physical verification 1628, the layout design is checked to ensure that manufacturing constraints are correct, such as DRC constraints, electrical constraints, lithographic constraints, and that circuitry function matches the HDL design specification. During resolution enhancement 1630, the geometry of the layout is transformed to improve how the circuit design is manufactured.

During tape-out, data is created to be used (after lithographic enhancements are applied if appropriate) for production of lithography masks. During mask data preparation 1632, the ‘tape-out’ data is used to produce lithography masks that are used to produce finished integrated circuits.

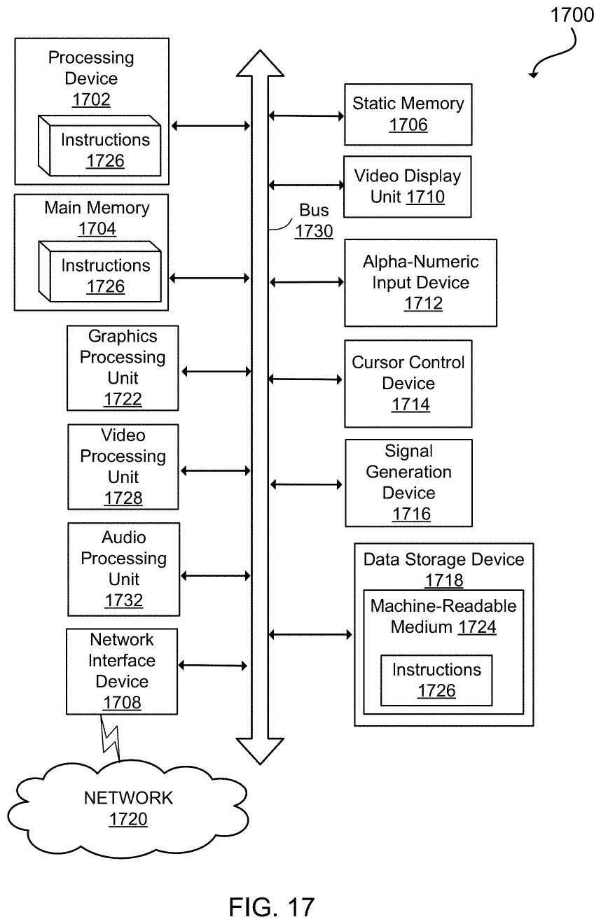

A storage subsystem of a computer system (such as computer system 1700 of FIG. 17) may be used to store the programs and data structures that are used by some or all of the EDA products described herein, and products used for development of cells for the library and for physical and logical design that use the library.

FIG. 17 illustrates an example machine of a computer system 1700 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1700 includes a processing device 1702, a main memory 1704 (e.g., read-only memory (ROM), flash memory, dynamic random access memory (DRAM) such as synchronous DRAM (SDRAM), a static memory 1706 (e.g., flash memory, static random access memory (SRAM), etc.), and a data storage device 1718, which communicate with each other via a bus 1730.

Processing device 1702 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1702 may also be one or more special-purpose processing devices such as an application specific integrated circuit (ASIC), a field programmable gate array (FPGA), a digital signal processor (DSP), network processor, or the like. The processing device 1702 may be configured to execute instructions 1726 for performing the operations and steps described herein.

The computer system 1700 may further include a network interface device 1708 to communicate over the network 1720. The computer system 1700 also may include a video display unit 1710 (e.g., a liquid crystal display (LCD) or a cathode ray tube (CRT)), an alphanumeric input device 1712 (e.g., a keyboard), a cursor control device 1714 (e.g., a mouse), a graphics processing unit 1722, a signal generation device 1716 (e.g., a speaker), graphics processing unit 1722, video processing unit 1728, and audio processing unit 1732.

The data storage device 1718 may include a machine-readable storage medium 1724 (also known as a non-transitory computer-readable medium) on which is stored one or more sets of instructions 1726 or software embodying any one or more of the methodologies or functions described herein. The instructions 1726 may also reside, completely or at least partially, within the main memory 1704 and/or within the processing device 1702 during execution thereof by the computer system 1700, the main memory 1704 and the processing device 1702 also constituting machine-readable storage media.

In some implementations, the instructions 1726 include instructions to implement functionality corresponding to the present disclosure. While the machine-readable storage medium 1724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1702 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
selecting a set of samples from a larger number of samples comprising metrics measured on physical devices, wherein selecting the set of samples is based on distributions of the measured metrics;
setting parameters for a set of model instances corresponding to the set of samples, such that simulation of the set of model instances using the parameters predicts metrics that match the measured metrics from the set of samples;
calculating principal components of variances of the parameters;
fitting, by a processor, non-linear models to the parameter variances as a function of the principal components;
applying statistical variations of the principal components to the non-linear models to yield statistical variations in the parameters; and
applying statistical variations of the parameters to yield statistical variations of a property of a simulated device.

2. The method of claim 1 wherein selecting the set of samples comprises selecting samples based on process limits of the distributions of individual measured metrics.

3. The method of claim 1 wherein selecting the set of samples comprises selecting samples based on quantiles of the distributions of individual measured metrics.

4. The method of claim 1 wherein selecting the set of samples comprises selecting samples based on quantiles of bivariate distributions of pairs of individual measured metrics.

5. The method of claim 1 wherein fitting non-linear models to the parameter variances comprises fitting the non-linear models to the parameter variances as a function of a basis comprising only those principal components with eigenvalue above a threshold.

6. The method of claim 1 wherein the applied statistical variations of the principal components are Gaussian.

7. The method of claim 1 wherein the selected set contains N samples and N≥2×DoF×I, DoF=degrees of freedom in the parameters due to process variations, and I=number of measured metrics.

8. The method of claim 1 wherein the selected set contains N samples and N≥2×(DoF+O)!/(DoF!*O!), DoF=degrees of freedom in the parameters due to process variations, and O=order of the non-linear model.

9. A system comprising:
a memory storing instructions; and
a processor, coupled with the memory and to execute the instructions, the instructions when executed cause the processor to:
select a set of samples from a larger number of samples comprising metrics measured on physical semiconductor or superconductor devices, wherein selecting the set of samples is based on distributions of the measured metrics;
set parameters for a set of model instances corresponding to the set of samples, such that simulation of the set of model instances using the parameters predicts metrics that match the measured metrics from the set of samples;
calculate principal components of variances of the parameters;
fit non-linear models to the parameter variances as a function of the principal components;
apply statistical variations of the principal components to the non-linear models to yield statistical variations in the parameters; and
apply statistical variations of the parameters to yield statistical variations of a property of a simulated device.

10. The system of claim 9 wherein same metrics measured on different physical devices vary as a result of process variation, and the model instances are instances of SPICE models.

11. The system of claim 9 wherein the non-linear models are also a function of geometry of the devices.

12. The system of claim 9 wherein the larger number of samples are measured on physical devices from multiple different die and the die are from multiple different wafers, but all wafers are processed using a same process node.

13. The system of claim 9 wherein the devices are CMOS devices and the metrics comprise drain current saturation region, drain current linear region, threshold voltage saturation region, threshold voltage linear region, gate leakage current, transconductance, output conductance, intrinsic gate capacitance, and drain/source capacitance.

14. The system of claim 9 wherein the devices are superconductor devices and the metrics comprise critical current, normal resistance, subgap resistance, gap voltage, and gap width.

15. A non-transitory computer readable medium comprising stored instructions, which when executed by a processor, cause the processor to:
select a set of samples from a larger number of samples, wherein the samples comprise metrics measured on physical devices and samples are selected for the set based on distributions of the measured metrics; and
estimate statistical variations of a property of a simulated device, based on the measured metrics in the selected set.

16. The non-transitory computer readable medium of claim 15 wherein the selected set contains at least 72 samples.

17. The non-transitory computer readable medium of claim 15 wherein samples are selected for the set based on quantiles of the distributions of individual measured metrics.

18. The non-transitory computer readable medium of claim 15 wherein samples are selected for the set based on quantiles of bivariate distributions of pairs of individual measured metrics.

19. The non-transitory computer readable medium of claim 18 wherein the bivariate distributions are characterized by a major axis and a minor axis, and samples are selected for the set based on quantiles along the major axis and along the minor axis.

20. The non-transitory computer readable medium of claim 15 wherein the set of samples further comprises a composite sample calculated as an average of a plurality of samples.
